(19) United States
(12) Patent Application Publication
(10) Pub. No.: US 2004/0211867 A1
(43) Pub. Date: Oct. 28, 2004

(54) Suction cup assembly with pointed upper shell rigid backing platform

(76) Inventor: Patrick W. Doyle, Fort Bragg, CA (US)

Correspondence Address: JOHNSON & STAINBROOK, LLP, 3558 ROUND BARN BLVD., SUITE 203, SANTA ROSA, CA, 95403, US

(21) Appl. No.: 10/831,454

(22) Filed: Apr. 23, 2004

Related U.S. Application Data
(60) Provisional application No. 60/464,942, filed on Apr. 23, 2003.

(51) Int. Cl. F16B 47/00

(52) U.S. Cl. 248/205.5

(57) ABSTRACT

A suction cup assembly including a suction cup member and a rigid backing platform with bracing structures. The suction cup member has a concave side, convex side, and an outer edge, and is fabricated from generally pliable material. The backing platform is attached to the convex side of the suction cup member at a fused contact area. The backing platform includes a central portion and a plurality of bracing structures (such as outriggers, polygonal corners, and the like) extending outwardly and downwardly from the central portion and over the concave side of the suction cup member toward the outer edge of the suction cup member.

### CROSS REFERENCE TO RELATED APPLICATIONS

The present application claims the benefit of the filing date of U.S. Provisional Patent Application Ser. No. 60/464,942, filed Apr. 23, 2003.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to suction cup-holding devices, and more specifically to an improved suction cup assembly which has increased holding power, is more durable, and less expensive to manufacture per pound of holding power. Still more particularly, the present invention is composed of a soft bottom suction cup member and a completely rigid upper shell backing platform with points, stars or claws that extend from the center as outriggers.

### BACKGROUND INFORMATION AND DISCUSSION OF RELATED ART

When under loads, suction cups typically fail for several reasons; firstly, due to deformation of the vacuum bubble in the center of the suction cup; secondly due to the hardening of the main suction cup body materials over time; and thirdly, due to distortion or vibration of the stem or the area of attachment. A typical, standard suction cup device includes a concave pliable body that is pressed against an attaching surface to create a vacuum in the middle of the concave body. It relies on atmospheric pressure to hold it against a mounting surface. After being pressed against the attaching surface, the pliable body suction cup body material will retain its normal shape, causing a vacuum and allowing the suction cup assembly to become affixed to the attaching surface. If air leaks under the body of the suction cup material, or if the air bubble is completely forced flat and out by downward pressure, the holding power will diminish until the suction cup fails. A stronger and longer lasting suction cup will result if the deformation of the vacuum bubble can be minimized, the location of the air bubble can be centralized, and the aging of the suction cup materials can be slowed.

Prior art inventions have attempted to address these problems by various mean. Some of the prior art devices employ tightening mechanisms to pull the suction cup stem out from the attaching surface and increase the suction force of the vacuum bubble. Other prior art devices employ cam-operating levers that have rigid baskets over the suction cup body that work to pull the stem center of the suction cup to increase the space under the cup and, in some cases, with flanges to hold down the edges. These latter devices do not work to optimally centralize the air bubbles and allow the bubble to escape to a side opposite the applied leverage.

Other prior art devices have been devised to include a rigid basket on the pliable suction cup materials, some with radial grooves in the suction cup material. These devices are intended to increase the holding power of the suction cup without the camming devices mentioned above. However, these devices require the assembly of multiple pieces.

The prior art devices do not work on curved surfaces, such as a significantly curved car roofs or boat hulls or in gutters and deep grooves. Additionally, the prior art devices use multiple parts that add to the weight, complexity and manufacturing costs of the suction cup assembly and lose efficiency with direct downward pressures, particularly when applied on even slightly curved surfaces. Finally, many prior art sucking devices use flat or die cut flexible materials in a gasket-like fashion. These have no vacuum memory of their own.

The prior art does not teach any apparatus that has the advantages of the present invention. The present invention not only increases the holding power of the suction cup, it aids in resisting rotation, twisting and flattening of the cup under load while also allowing the main suction cup body maximum freedom to return to and hold its original shape.

Exemplary patents showing the prior art devices include: U.S. Pat. No. 5,176,346 to Liu, which discloses a suction cup device having an attached concave resilient member that acts to hold in the place the suction cup.

U.S. Pat. No. 5,0290,786 to Wu shows a suction cup that combines a soft sucking pad with a superimposed pressing portion attached to the cup and has an extended flange to hold down the edges.

U.S. Pat. No. 3,750,991 to Ragir teaches a suction cup device with a reaction member that encloses the elastic diaphragm to maintain its shape and grip.

U.S. Pat. No. 4,453,285 to Rosberg discloses a device adapted for attachment to a surface by means of a suction device. The suction device employs a rigid backing member over the soft cup.

U.S. Pat. No. 5,133,524 to Liu shows a suction device with two concave elements, a soft suction cup and a harder backing that applies pressure to the outer rim of the cup.

U.S. Pat. No. 1,871,113 to Compter teaches a device that utilizes a mechanical resilient member to press the soft suction cup into a firm grip.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

The present invention provides a simpler solution to increasing suction cup strength and endurance. It is easier to manufacture, less expensive, and more efficient than either the complex camming devices or the suction cup baskets found in the prior art. Further, the present invention is smaller, lighter and has more holding power by weight than the prior art suction devices.

The present invention provides a pointed upper shell rigid backing platform that can be used as a site for attaching various hanging devices, such as hooks, pins, cleats, threaded inserts, and the like, that can be used to affix objects to the suction cup assembly and thereby to the attaching surface.

### BRIEF SUMMARY OF THE INVENTION

The present invention comprises a suction cup assembly which combines: (1) a pointed upper shell rigid backing platform with points, stars or claws as outriggers affixed at its underside center; with (2) a downwardly concave, pliable bottom suction cup member. The outriggers, terminating in points, stars or claws, are not adhesively joined to the suction cup member.

The pointed upper shell rigid backing platform with the outrigger stars, points or claws is shaped in a downwardly concave fashion. There can be any number of stars, points or claws as outriggers, from one to multiple numbers. The points, stars or claws are typically symmetrically spaced, emanating from the center of the rigid back. However, there may be certain applications where the outrigger points, claws or stars are asymmetrically spaced.

When pressing the suction cup assembly onto a suitable surface for attachment, the backing platform will urge the suction cup member material away from the attaching surface. This provides a more centered and conformed vacuum bubble between the pliable soft bottom suction cup member and the attaching surface. The downward vacuum will urge the outriggers on the pointed upper shell rigid backing platform downward, sealing the vacuum bubble perimeter and keeping the bubble centered and sealed while under various stresses. This feature more effectively attaches the suction cup assembly body to the attaching surface, which increases the holding power of the suction cup assembly. The present invention resists release if an edge is lifted, if the suction cup assembly is rotated, if the suction assembly is placed on curved surfaces, or if pressure is applied to the outside of the cup.

The soft bottom suction cup member combined with the pointed upper shell rigid backing platform provides an improved, stronger holding suction cup assembly. To support a comparable load held by an ordinary suction cup, the inventive apparatus will be smaller in size and less expensive to manufacture. In addition, the pointed upper shell rigid backing platform provides a surface that can be used to affix a variety of hanging devices onto the suction cup assemblies, such as threaded inserts, independent connectors with an outer thread, load bearing hooks, pins or clears or any similar item that can be used to hold articles that wish to be affixed to the attaching surface by the suction cup assembly.

The component parts, the pointed upper shell rigid backing platform and the attachment hanging devices can be manufactured with any suitably rigid material, such as plastic, metal and so forth. The soft bottom suction cup member and the pointed upper shell rigid backing platform can be of any size. However, the pointed upper shell rigid backing platform, including its outriggers and points, claws or stars, must not extend to the perimeter of the suction cup member.

It is therefore an object of the present invention to provide a new and improved suction cup assembly having a pointed upper shell rigid backing platform in a star or claw configuration, or any platform with points, allows the soft bottom suction cup to maintain maximum memory and stability of the vacuum bubble under load.

It is a further object to provide a suction cup assembly that resists turning up at the edges for improved surface contact.

It is yet another object of the present invention to provide a suction cup assembly with a pointed upper shell rigid backing platform resists the vacuum bubbles tendency to be drawn to the outer edge and cause deformation and early release.

It is still a further object of the invention to provide an improved suction cup assembly having a pointed upper shell rigid backing platform that keeps the vacuum bubble centered.

Another object of the invention is to provide a suction cup assembly having a pointed upper shell rigid backing platform helps keep the vacuum bubble in an optimal configuration even (with an undistorted vacuum area) when an outer edge is partially released.

It is yet another object of the present invention to provide an improved suction cup assembly having a pointed upper shell rigid backing platform with outriggers emanating from its center with angled points, such as sharp pointed claws or sharp pointed stars that dig into the soft bottom suction cup and resist rotation of the suction cup under load.

Still a further object of the present invention is to provide an improved suction cup assembly having a soft bottom suction cup member with a pointed upper shell rigid backing platform that provides a more efficient site for attaching stems, cleats, hooks, pins and the like to the suction cup assembly, as well as causing a wider, braced, lower center of gravity to resist stress loads in a variety of situations without depending on the flexible stem to handle the stresses of the load.

Yet another object of the present invention is to provide an improved suction cup assembly wherein the primary pliable suction cup member is firmer and retains its original memory shape to maximize the holding power.

Another object of the present invention is to provide an improved suction cup assembly having inner angles between the points that allow the memory shape of the main flexible sucking body to function optimally.

A still further object of the present invention is to provide an improved suction cup assembly having a pointed upper shell rigid backing platform with outrigger tips that are not affixed, glued or molded to the suction cup member, such that when the suction cup assembly is not in use the main sucking body is allowed maximum freedom to return and hold its original memory shape.

Another object of the present invention is to provide an improved suction cup assembly having an upper shell rigid backing platform with points, stars and claws that press into the main soft bottom suction cup member at the extremity of the points, thereby squeezing more air from the center vacuum while the flexible soft bottom suction cup body urges the backing platform up, thereby creating more vacuum.

Still a further object of the present invention is to provide an improved suction cup assembly with a rigid backing platform having outriggers that terminate in points, stars or claws that act as bracing stakes in the suction cup member to counteract or assist in opposing adverse lateral, shear, rotational or twisting forces, on the suction cup assembly. This contrasts with a conventional suction cup assembly, which has a stem or attachment allows the entire sucking body to be distorted under such forces as well as the stem, itself.

A still further object of the present invention is to provide an improved suction cup assembly which deforms under pressure to provide even stronger suction; specifically, when downward pressure is applied, the soft bottom suction cup memory forces the center of the soft cup to elevate, giving rise to a stronger vacuum.

Yet another object of the present invention is to provide an improved suction cup assembly having a pointed upper shell rigid backing platform that creates cone-like support over the soft cup that resists downward pressure that would otherwise flatten the cup and destroy the functional vacuum.

A further object of the present invention is to provide an improved suction cup assembly having a pointed upper shell rigid backing platform that allows a variety of attachments, pins, hooks, stems and screws at various optimum physical locations.

Still a further object of the present invention is to provide an improved suction cup assembly having a pointed upper shell rigid backing platform that can be made from opaque materials to block damaging radiation that age and harden the suction cup member. By attenuating heat transfer and reflecting light energy, the suction cup member material is shielded from light and heat.

Yet another object of the present invention is to provide an improved suction cup assembly having a rigid backing platform with outriggers having points, claws and/or stars at the outrigger tips that can be made in a variety of shapes and sizes to increase leverage or decrease manufacturing cost.

Still a further object of the present invention is to provide an improved suction cup assembly having an angled pointed upper shell rigid backing platform. This is less expensive to manufacture than more complicated rigid backings as the present invention may be made without any assembly other than a mold.

Another object of the present invention is to provide an improved suction cup assembly comprising only a few parts that can be joined either as part of a molding process or by using a simple adhesive, making the present invention less costly to manufacture per pound of holding power.

A further object of the present invention is to provide an improved suction cup assembly having a flexible sucking surface of the soft bottom suction cup in the main suction cup body that can be pliably folded to nearly vertical angles when the pointed upper shell rigid backing platform and outrigger points are bounded within the flat surface of the opposing vertical surface. The extra flexible material blanketing the vertical opposing surface helps the holding power of the suction cup assembly on non-flat surfaces, such as near corners or within grooves and gutters. This gives the suction cup assembly more holding power on curved surfaces as well.

Yet another object of the present invention is to provide an improved suction cup assembly having a rigid backing platform that can be easily adapted to include or accommodate various attachments, including, but not limited to hooks, screws, threaded inserts, pins, cleats, and the like.

A still further object of the present invention is to provide an improved suction cup assembly having a pointed upper shell rigid backing platform that can be manufactured from any material, such as plastic or metal, and in varying sizes, without modification to the underlying design of the invention.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty that characterize the invention are pointed out with particularity in the claims annexed to and forming part of this disclosure. The invention does not reside in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a perspective view of the suction cup assembly of the present invention;

FIG. 2 is an exploded perspective view of the inventive suction cup assembly showing the fused area between the soft bottom suction cup and the pointed upper shell rigid backing platform;

FIG. 3 is a side view in elevation of the suction cup assembly when not in use;

FIG. 4 is a side view in elevation of the suction cup assembly when in use and pressed against an attaching surface;

FIG. 5 is a top view of the inventive suction cup assembly;

FIG. 6a is a bottom view of the inventive suction cup assembly with a star-shaped fused area;

FIG. 6b is a bottom view showing an alternative polygonal shape for the fused area;

FIG. 7 is a cross-sectional side elevation view of the suction cup assembly attached to a vertical attaching surface showing the suction cup assembly under the load of a shearing force;

FIG. 8 is a top view of a suction cup assembly under sheer or rotational force;

FIG. 9 is a side view in elevation of a suction cup assembly, showing a second preferred embodiment in which the inventive apparatus has a soft bottom cup with flexible material disposed between the outriggers;

FIG. 10 is a side view in elevation of a third preferred embodiment of the inventive suction cup assembly in which the apparatus includes a multi-purpose vacuum cleat with a vertical and horizontal holes for holding shafts, masts, ropes, in numerous positions and a hook designed to capture a shaft, rope, cord, and the like;

FIG. 11 is a top view of the suction cup assembly of FIG. 10;

FIG. 12 is a top view of a fourth preferred embodiment, showing the suction cup assembly having a square shaped backing platform; and

FIG. 13 is a top view of a fifth preferred embodiment, showing the inventive apparatus having a triangular backing platform.

### DRAWING REFERENCE NUMERALS

100 first preferred embodiment of inventive suction cup assembly

110 pointed upper shell rigid backing platform (the “backing platform”)

110a bottom side of backing platform

110b upper side of backing platform

115 upper surface of suction cup member

120 suction cup member

120a underside of suction cup member

120b upper side of suction cup member

120c outer edge, or circumference, of suction cup member

125 contact area between suction cup member and backing platform

130 release tab

140 contact area on backing platform

150 contact area on suction cup member

160 outriggers

160a arcuate region between outriggers

160b center of arcuate region

165 central portion of backing platform

170 terminal end of outrigger

180 contact area diameter

200 vacuum chamber

210 suction cup member material

230 star-shaped fused contact area

235 hexagonal fused contact area

240 star points in fused contact area

245 vertices of hexagonal fused contact area

280 sheer force

290 furthest point proximate edge of fused contact area

300 bottom perimeter of vacuum chamber

310 edge of vacuum chamber

320 outer portion of suction cup member

330 displacement due to sheer force

350 rotational force applied to backing platform

360 rim of pliable (suction cup member) material

400 second preferred embodiment of inventive suction cup assembly

415 nubs of suction cup member material

420 suction cup member

460 arcuate region (interstices) between the outriggers

500 third preferred embodiment of inventive suction cup assembly

510 backing platform

520 multi-purpose vacuum cleat

530 through holes

540 hook

550 through hole in hook

600 fourth preferred embodiment of inventive suction cup assembly

610 square shaped backing platform

650 square fused area

700 fifth preferred embodiment of inventive suction cup assembly

710 triangular backing platform

750 triangular fused area

### DETAILED DESCRIPTION OF THE INVENTION

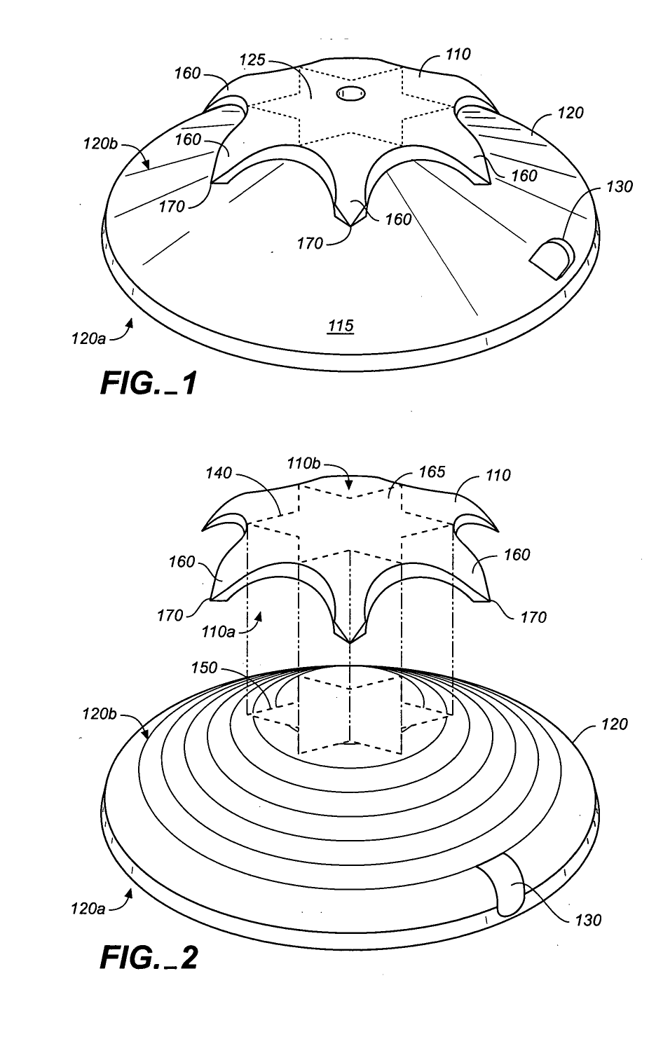

Referring to FIGS. 1 through 11, wherein like reference numerals refer to like components in the various views, there is illustrated therein a new and improved suction cup assembly, generally denominated 100 herein.

FIGS. 1 and 2 illustrate a first preferred embodiment of the inventive apparatus. These views show that the assembly comprises two principal parts: the first part is a soft and pliable concave suction cup member 120, concave on its underside 120a and convex on its upper side 120b; the second is a pointed upper shell rigid backing platform (referred to hereinafter as the “backing platform”) 110, which is affixed to the upper surface 115 of the suction cup member at a contact area 125. The backing platform includes outriggers 160 radiating out from a central portion 165, each outrigger terminating at its tip in a star, point or claw 170. The backing platform is concave on its bottom side 110a and convex on its upper side 110b.

The suction cup member 120 illustrated is a conventional, flexible, springy, circular concavo-convex soft bottom suction cup, as is well known in the art. A release tab 130 is disposed on the upper surface 115 of the suction cup member in a raised and erect orientation, and has sufficient height and width to be easily grasped with fingers and pulled up and away from the attaching surface.

FIG. 2 is an exploded perspective view showing one of the ways in which the backing platform 110 may be affixed to the suction cup member 120. The contact areas 140, 150, respectively, on which the backing platform 110 and suction cup member 120 are fused together is shown as a star-shaped area 140 on the bottom of the backing platform 110 and a complementary star-shaped area 150 on the upper surface of the suction cup member 120. Several means, all well known in the art, may be employed to effect the fusion, from a fusion effected in the molding process itself to the use of suitable adhesives, and other means well known in the art. There is nothing imperative in having a particular shape of the contact area shown. In fact, a number of configurations, including amorphous, could be employed, as long as sufficient strength in the fusion is provided. Preferably, however, the shape of the fusion area strikes a balance between providing maximum structural strength while also leaving a maximum possible area of the suction cup unfused so that its shape memory is unaffected.

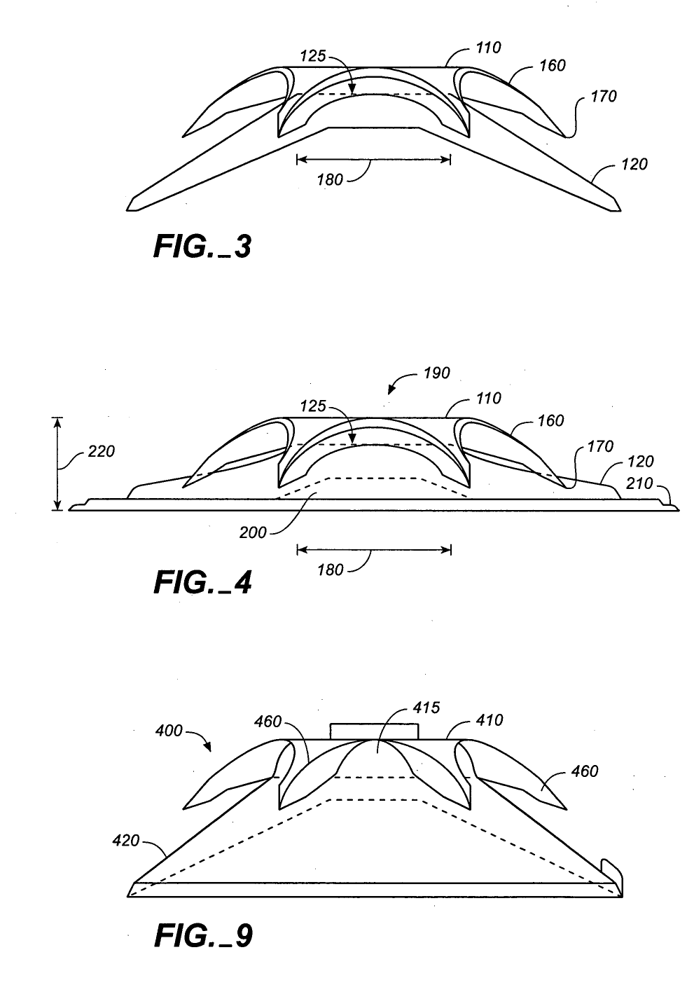

FIG. 3 is a side view in elevation showing that the backing platform 110 is provided with outriggers 160, each having a terminal end formed into a point, star, or claw 170. This side view shows that the contact area diameter 180 does not extend outside the central portion 165 of the backing platform and down the length of the outriggers 160, but is confined within the central portion. Accordingly, the outriggers 160 and points 170 are not affixed to the suction cup member 120.

FIG. 4 is a side view in elevation showing the suction cup assembly under a depressive load. With the application of downward pressure, the points 170 dig into the soft and pliable suction cup member 120. The backing platform 110 is pressed close to the attaching surface and air is forced out of the vacuum chamber 200.

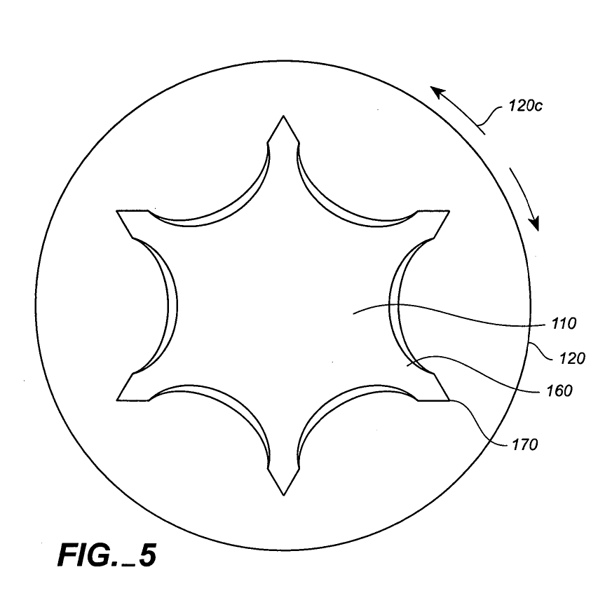

FIG. 5 is a top view of the inventive suction cup assembly which illustrates that the points at the terminal ends 170 of the outriggers 160 of the backing platform 110 do not extend to the outer edge or circumference 120c of the suction cup member 120.

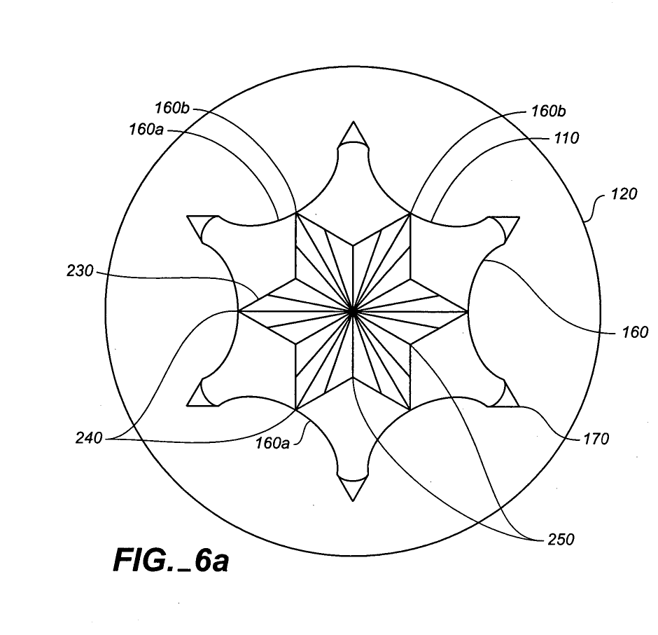

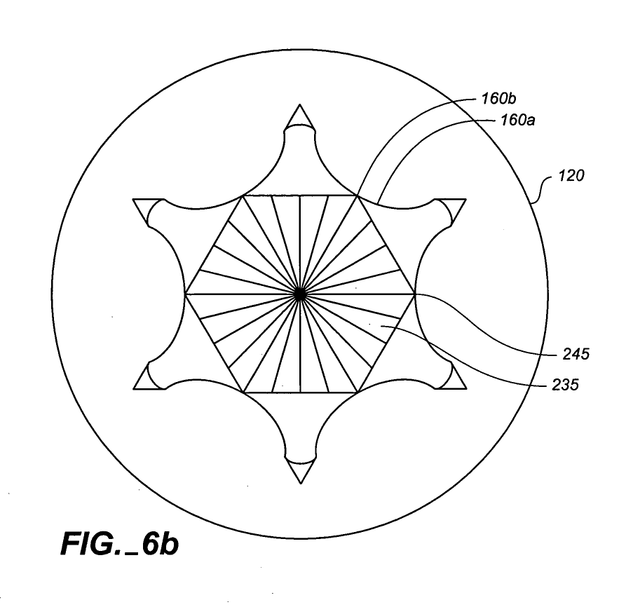

FIG. 6a is a bottom view of a the suction cup assembly of FIG. 5 that shows a possible shape for the fused contact area 230. In this instance the fused area forms a six-sided star, and the tip of the star points 240 of the fused area extend to the center 160b of the arcuate region 160a between the outriggers 160 of the backing platform 110.

FIG. 6b is also a bottom view of the suction cup assembly, showing an alternative fused contact area 235. In this instance, the fused area is hexagonally shaped and includes vertices 245 that extend to the center 160b of the arcuate interstices 160a between the outriggers of the backing platform. This shows the maximum desirable fused area possible without significantly diminishing the shape memory characteristics and behavior of the pliable suction cup member 120.

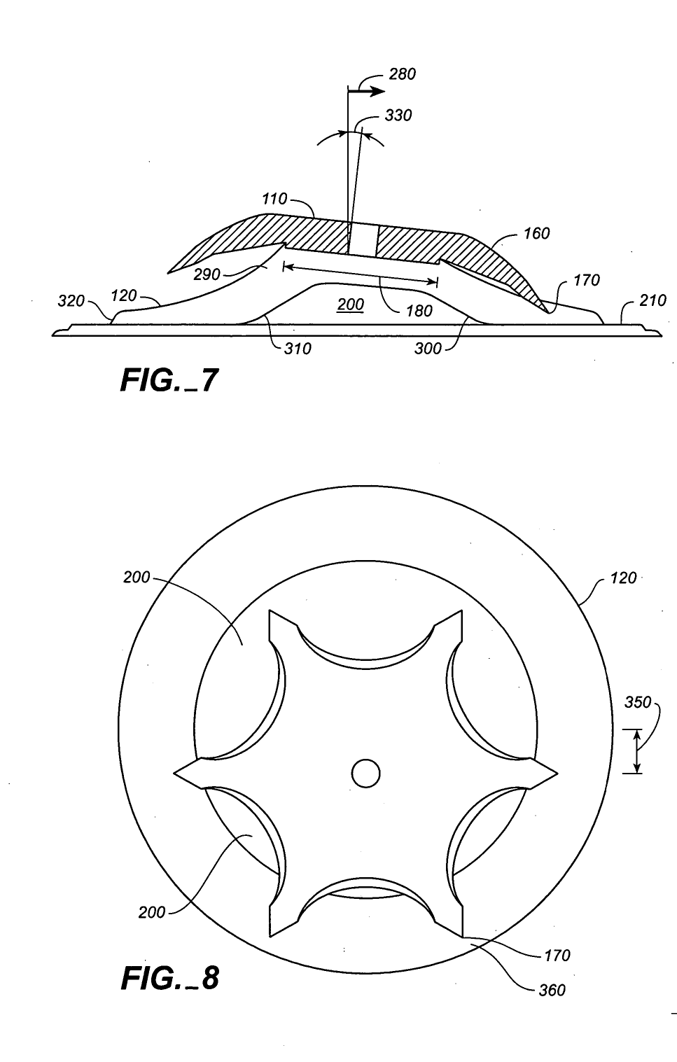

FIG. 7 is a cross-sectional side view showing the suction cup assembly under shear stress with the points 170 of the outriggers 160 digging into the suction cup member 120 to resist rotation and twisting as well as providing minimal amount of movement of the pointed upper shell rigid backing platform 110. When a sheer force 280 is applied to the backing platform, the backing platform differentially depresses and thereby transfers pressure to the outriggers below the force. The points at the tip of the outriggers are sharpened only enough to embed into the pliable suction cup member without cutting or otherwise damaging it. Accordingly, the outrigger points in the direction of the sheer stress dig into the surface of the suction cup member, are stopped by resistance communicated from the mounting surface through the suction cup member material 210, and prevent rotation or any further movement of the backing platform. Thus the displacement 330 of the backing platform is limited. Because the outrigger points press into the pliable suction cup material, they also force the bottom of the vacuum chamber to remain low and immediately under the outrigger points. This bracing effect transfers energy back through the backing platform to the opposite and furthest point 290 proximate the edge of the fused area 180, thereby allowing the entire top of the vacuum chamber, and the available pressure in the chamber, to be used to resist distortion and lifting. Further, this keeps the bottom perimeter 300 and edge 310 of the vacuum chamber 200 from rising, migrating to the outer portion 320 of the suction cup member, and allowing an air intrusion into the vacuum.

FIG. 8 shows the behavior of the inventive apparatus under a rotational force 350. When such a force is applied to the backing platform, the outrigger points 170 dig into the suction cup member on the rim 360 of the pliable material and force the bottom of the vacuum chamber to remain low proximate those points. This keeps the top of the vacuum chamber from rising to the outer perimeter of the outrigger points and releasing.

FIG. 9 illustrates a second preferred embodiment 400 of the inventive suction cup assembly, showing the suction cup member 420 having nubs 415 of suction cup member material disposed between the interstices of the outriggers 460, which provide increased stability, holding power and total memory of the suction cup member 420. Alternatively, the suction cup member material can enclose the outriggers. This provides similar increases in suction strength. Both embodiments reduce manufacturing costs by eliminating the assembly step for assembling the backing platform onto the pliable main suction cup body.

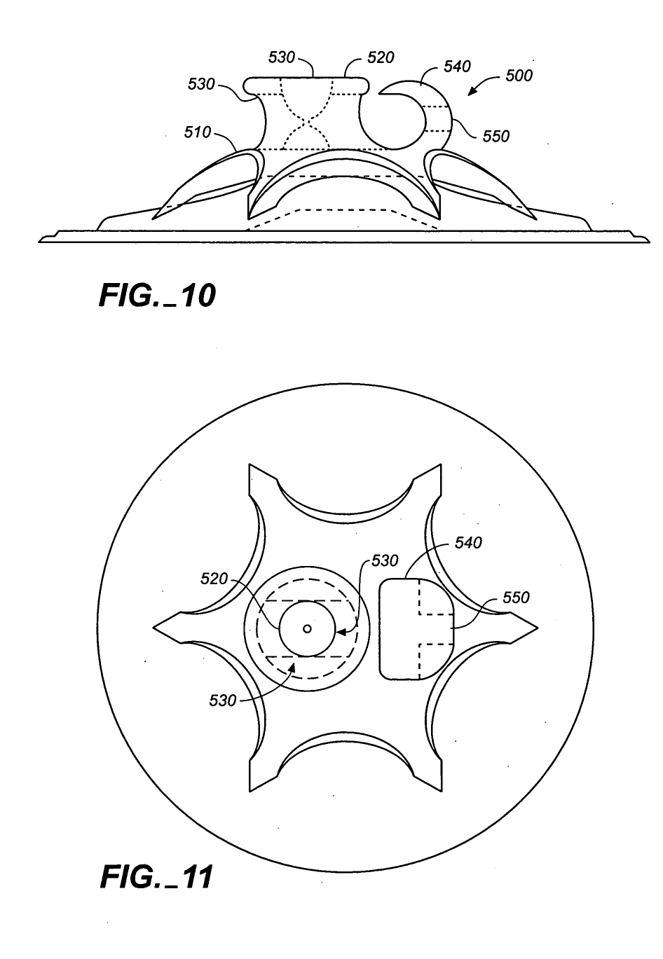

FIG. 10 is a side view in elevation of a third preferred embodiment 500 of the inventive suction cup assembly. In this embodiment, the backing platform 510 includes a multi-purpose vacuum cleat 520 having a variety of vertical and horizontal through holes 530 and a hook 540, also having a through hole 550 and providing additional sites for attachment by multiple means.

FIG. 11 is a top view of the suction cup assembly of FIG. 10.

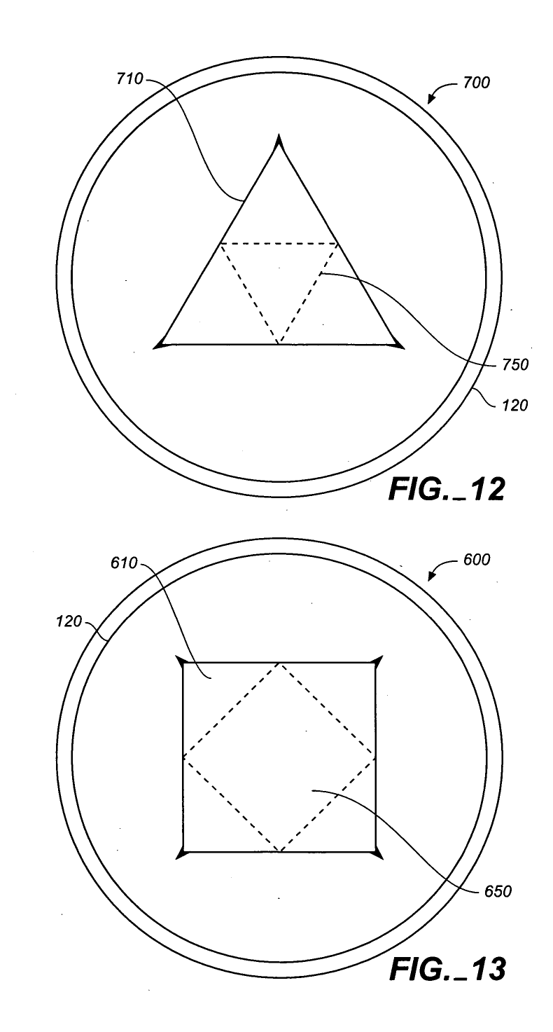

FIG. 12 is a top view of a fourth preferred embodiment 600, showing the suction cup assembly having a square shaped backing platform 610 and an optimally shaped square fused area 650, the sides of which are substantially the same length as those of the backing platform sides, but rotated 45 degrees. The fused area also defines the central portion of the backing platform, and the unfused corners of the backing platform function in the same manner as the outriggers and outrigger points do in the first preferred embodiment of the present invention.

FIG. 13 is a top view of a fifth preferred embodiment 700, showing the inventive apparatus having a triangular backing platform 710 and a complementary triangular fused area 750. Again, the fused area comprises the central portion of the backing platform, while the unfused portion of the backing platform, terminating in the points of the triangle, functions in the same fashion as the outriggers of the first preferred embodiment. These final embodiments again incorporate the principle of an optimum fused area, providing a balance of strength with the minimum fused area to rigidify the suction cup material and thereby compromise suction cup shape memory.

Accordingly, it will be appreciated that the backing platform could be any of a number of suitable shapes, particularly polygonal or pointed, as long as the fused area is limited under the backing platform so that a number of structures extend outward and over the upper surface of the suction cup member. In fact, from the foregoing it will be appreciated that the inventive apparatus, reduced to its essence, is a suction cup assembly comprising a suction cup member having a concave side, convex side, and an outer edge, and the suction cup member is fabricated from generally pliable material. The apparatus further includes a rigid backing platform affixed to the convex side of the suction cup member at a fused contact area. The backing platform includes a central portion and a plurality of bracing structures (such as outriggers, polygonal corners, and the like) extending outwardly and downwardly from the central portion and over the concave side of the suction cup member toward the outer edge of the suction cup member.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A suction cup assembly, comprising:
a suction cup member having a concave side, convex side, and an outer edge, said suction cup member made of generally pliable material; and
a rigid backing platform affixed to said convex side of said suction cup member at a fused area, said backing platform including a central portion and a plurality of bracing structures extending outwardly and downwardly from said central portion and over said concave side of said suction cup member toward said outer edge of said suction cup member.

2. An apparatus as in claim 1, further including a release tab disposed on the concave side of said suction cup member.

3. An apparatus as in claim 1, wherein said bracing structures do not extend to said outer edge of said suction cup member.

4. An apparatus as in claim 1, wherein said bracing structures comprise a plurality of outriggers, and wherein said backing platform includes an arcuate region between each outrigger, each of said outriggers having a point at its terminal end, and each arcuate region including a center.

5. An apparatus as in claim 4, wherein each of said outriggers has a star at its terminal end.

6. An apparatus as in claim 4, wherein each of said outriggers has a claw at its terminal end.

7. An apparatus as in claim 4, wherein said fused area forms a six-sided star having points, each one of said points extending to the center of one of said arcuate regions.

8. An apparatus as in claim 4, wherein said fused area is substantially polygonal and includes vertices, each one of which extends to the center of one of said arcuate regions.

9. An apparatus as in claim 4, further including nubs of suction cup member material disposed between said outriggers.

10. An apparatus as in claim 1, wherein said fusion area and said backing platform are polygonal in shape.

11. An apparatus as in claim 10, wherein said backing platform is substantially square and said fused area is a square rotated generally 45 degrees relative to said backing platform.

12. An apparatus as in claim 10, wherein said backing platform and fused area are triangular in shape.

13. An apparatus as in claim 1, wherein when a sheer or rotational force is applied to said backing platform, said pointed structures dig into said suction cup member.

14. An apparatus as in claim 1, wherein said backing platform includes a multi-purpose vacuum cleat having a at least one through hole.

15. An apparatus as in claim 14, wherein said backing platform further includes hook.

16. An apparatus as in claim 15, wherein said hook includes at least one through hole.
